(19) United States
(12) Patent Application Publication
(10) Pub. No.: US 2004/0259577 A1
(43) Pub. Date: Dec. 23, 2004

(54) System and method of simulating interactivity with a broadcoast using a mobile phone

(76) Inventor: Jonathan Ackley, Glendale, CA (US)

Correspondence Address: GREENBERG TRAURIG LLP, 2450 COLORADO AVENUE, SUITE 400E, SANTA MONICA, CA, 90404, US

(21) Appl. No.: 10/837,227

(22) Filed: Apr. 30, 2004

Related U.S. Application Data
(60) Provisional application No. 60/467,252, filed on Apr. 30, 2003.

(51) Int. Cl. H04B 17/00; H04Q 7/20

(52) U.S. Cl. 455/466

(57) ABSTRACT

A system and method of simulating interaction with television broadcasts using a mobile phone is disclosed. Messages are received by a mobile phone having software configured to interpret the messages and display the information contained in the message appropriately on the mobile phone display. By utilizing the mobile phone keypad, a user can respond to questions, or other information received by the phone relating to the broadcast. The messages are received in synchronization with a television broadcast such that the user can “interact” with the television broadcast.

### RELATED APPLICATIONS

This application claims priority to U.S. Provisional Application No. 60/467,252 entitled “Enhanced Television Mobile phone”, filed on Apr. 30, 2003, which is herein incorporated by reference in its entirety.

### BACKGROUND

1. Field

The disclosure relates to new systems and methods for remotely interacting with a television broadcast using a mobile phone.

2. General Background and State of the Art

Currently, it is difficult to play enhanced or interactive television games because most systems require hundreds or thousands of dollars of external hardware. At the very least, these interactive television systems require a computer connected to the Internet that is in the same room with a television. These minimum requirements severely limit the user to a single location.

There have been attempts to develop interactive television applications for handheld devices with wireless internet connections. The disadvantages of such attempts again include expensive hardware, and further difficulty in configuring the wireless connection. The wireless connection often had limited range.

Two screen interactive television systems are known, and are typically implemented as a “two screen system” by using a personal computer and a television simultaneously.

Therefore it is desired to implement interactive television applications on other devices that are inexpensive and easy to use.

### SUMMARY

A system and method of simulating interaction with television broadcasts using a mobile phone is disclosed. Messages are received by a mobile phone having software configured to interpret the messages and display the information contained in the message appropriately on the mobile phone display. By utilizing the mobile phone keypad, a user can respond to questions, or other information received by the phone relating to the broadcast. The messages are received in synchronization with a television broadcast such that the user can “interact” with the television broadcast.

Messages are created containing information relating to the content of a television or radio broadcast. For example, the broadcast may be a television game show, and messages may are created which represent the questions being asked on the game show. There may be a plurality of messages transmitted during the course of the television broadcast. Each of the messages is transmitted synchronously with the corresponding content within the broadcast. Ideally, the user receives the message and views the question on the mobile phone simultaneously with its display on the television. The user can therefore play the game along with the TV broadcast. The user can further send a response from the phone, allowing the user to “interact” with the television broadcast.

In one embodiment, the messages are simply a string of words or characters. In other embodiments, the messages may comprise other data such as graphics, images, animations, sounds, etc. Alternatively, the message itself may not contain the data to be displayed, but instead contains links to data that resides elsewhere. For example, the link may be a URL which would prompt the phone to retrieve the data by using an Internet connection.

In one embodiment, the messages are transmitted synchronously with a broadcast from servers at the broadcast end or some other centralized location to the mobile phone. Alternatively, in another embodiment, messages are saved to a file or database at a central location synchronously with a broadcast and the mobile phone repeatedly polls the server for newly received messages.

The mobile phone runs software, or a “client application” which interprets the received messages and displays the content within the messages appropriately. In some embodiments, the client application further provides the ability for the user to respond to received messages.

Examples of applications where the present disclosure could be applied include: allowing a user to play along with their favorite game show, fantasy sports game, transmitting play by play sports commentary to a user's mobile phone, transmitting coupons synchronously with television or radio commercials, voting (for example during a reality television show), polling the audience for their opinion, and providing television ratings and feedback. Users could also compare their scores and opinions with other interactive TV users.

Advantages of the present invention include extended range of use, more ease of use, and relatively inexpensive hardware requirements. By using the cellular phone system, the range is extended hugely. The user is no longer required to stay at home sitting in front of a computer in view of a television. Most cellular networks offer service nationally and can potentially be used while anywhere in the world.

An additional advantage of the present invention is that installation is simple. Users simple download a file, install it on their phones, then run it. Many telephones and service providers enable over the air downloads. Alternatively, the user may use a physical cable to install the application from a desktop or laptop computer. The program automatically connects them with the interactive TV content.

The hardware requirements for a user of the present invention are also relatively inexpensive. These mobile phones are much cheaper than computers and also already owned by many people. In many cases, a person does not need to purchase an additional piece of hardware—they simply use the mobile phone they already have to play along.

By using an Internet connected mobile phone to deliver interactive TV content, we reach a much wider audience than previous implementations of interactive TV. It gives the audience freedom to play or watch along from anywhere they go. By using phones capable of creating persistent Internet connections, messages reach consumers handsets well synchronized to the TV broadcast.

The foregoing and other objects, features, and advantages of the present invention will be become apparent from a reading of the following detailed description of exemplary embodiments thereof, which illustrate the features and advantages of the present disclosure in conjunction with references to the accompanying drawing Figures.

### BRIEF DESCRIPTION OF THE DRAWINGS

FIG. 1 is a block flow diagram of an exemplary embodiment wherein polling is implemented.

FIG. 2 is a block flow diagram of an exemplary embodiment wherein messages are transmitted directly to a mobile phone.

### DETAILED DESCRIPTION

In the following description of exemplary embodiments, reference is made to the accompanying drawings which form a part thereof, and in which are shown by way of illustration specific embodiments in which the present disclosure may be practiced. It is to be understood that other embodiments may be utilized and structural and functional changes may be made without departing from the scope of the present disclosure.

A system and method of simulating interaction with a television broadcast using a mobile phone is disclosed. Messages are received by a mobile phone having software configured to interpret the messages and display the information contained in the message appropriately on the mobile phone display. By utilizing the mobile phone keypad, a user can respond to questions, or other information received by the phone relating to the broadcast. The messages are received in synchronization with a television broadcast such that the user can “interact” with the television broadcast.

Messages are created containing information relating to the content of a television or radio broadcast. For example, the broadcast may be a television game show, and messages may represent the questions being asked on the game show. There may be a plurality of messages transmitted during the course of the television broadcast. Each of the messages is transmitted synchronously with corresponding relevant points in the broadcast. Ideally, the user receives the message and views the question on the mobile phone simultaneously with its display on the television. The user can therefore play the game along with the TV broadcast. The user can further send a response from the phone, allowing the user to “interact” with the television broadcast.

In one embodiment, the messages are simply a string of words or characters. In other embodiments, the messages may comprise other data such as graphics, images, animations, sounds, etc. Alternatively, the message itself may not contain the data to be displayed, but instead contains links to data that resides elsewhere. For example, the link may be a URL which would prompt the phone to retrieve the data by using an Internet connection. Alternatively, the link could be a partial path or address to data at another location.

In one embodiment, the messages are transmitted synchronously with a broadcast from servers at the broadcast end or some other centralized location to the mobile phone. Alternatively, in another embodiment, messages are saved to a file or database at a central location synchronously with a broadcast and the mobile phone repeatedly polls the server for newly received messages.

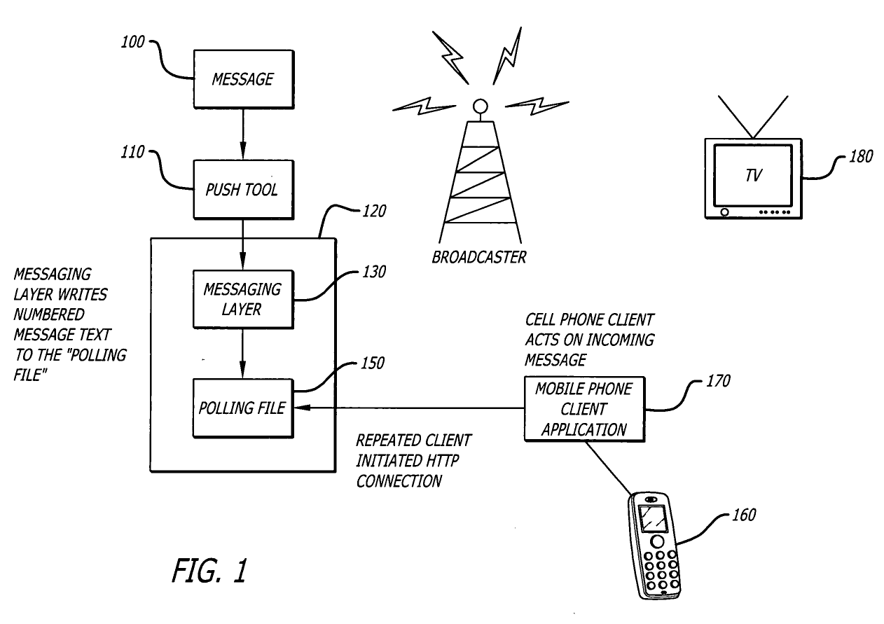

FIG. 1 is a block flow diagram illustrating an exemplary embodiment of such a polling implementation. Messages in the form of strings are created, as indicated at block 100, each corresponding to content contained within a television or radio broadcast. Messages are matched to the appropriate corresponding point of time during the broadcast, and sent in relative synchronicity with the broadcast. By relative synchronicity, it is intended that the messages can be sent slightly in advance of the broadcast signal. Timing does not need to be exact.

A software application located at the broadcast end may be responsible for transmitting each of the messages such that they are synchronized with the broadcast. For example, in one embodiment a “push tool” as shown at block 110 is used to transmit each message in time with the corresponding portion of the broadcast. The push tool 110 transmits messages to a server 120. The same software, or a separate application, herein called the “messaging layer” writes the message to a file 150 on the server 120. The messaging layer 130 labels each message it receives. For example, in one embodiment, the messaging layer 130 labels each message with a number, incrementing the number each time a message is received. The labeled messages are then written to a file or database 150 on the server 120.

Mobile phone 160 comprises a client application 170 which when run, creates a connection with server 120 and reads the contents of the file 150. The connection may, for example be created using HTTP, TCP/IP, or UDP networking protocols. The file 150 may simply be a text file, with each message appearing on a new line (separated by a line break). This way, the first/top line of the text file only needs to be read. In such an embodiment, the mobile phone reads the first line of the text file repeatedly. The application resident on the mobile phone notes the label, (in one embodiment, a number) of the last read/received message. If the label has changed—for example, the message number has incremented since the last received message, the mobile phone retrieves the content of the message for immediate display on the mobile phone. The client application on the mobile phone again notes the label, or message number of the message displayed so that it can distinguish new messages from already received messages. Mobile phone 160 runs a client application which repeatedly loads this file, reading the file and displaying new messages found within the file.

The file could also be a database. For example, each message could be labeled and added as a new database record within the database. The client application would then know to query the database for the most recent database record.

For example, a play along trivia game can be implemented for an Internet-enabled mobile phone. In an exemplary embodiment, the application resident on the mobile phone is developed in Java 2 Platform Micro Edition (J2ME), based on Sun Microsystem's Internet-standard Java™ programming language. The J2ME platform is the java platform for consumer and embedded devices such as mobile phones, PDA's, TV set top boxes, and in-vehicle telematic systems. Mobile phones such as the Motorola i50sx, i85s, and the i90c are just a few examples of mobile phones currently loaded with the Java 2 Micro Edition software. The J2ME platform provides a broad range of networking protocols.

A user could download the application over the wireless network for installation on their phone. Alternatively, the application could be pre-installed on the mobile phone prior to its purchase by the user. Alternatively, the user could download the software using an Internet connection to their desktop or laptop computer, and later transfer the program to their mobile phone for installation. For example, data transfer cables can often be purchased for transmitting data from a computer to a mobile phone. Also, Bluetooth (IEEE 802.15) and infrared communications are other methods which allow for transmission of data between a computer and mobile phone.

Once installed on the phone, the user runs the application. As mentioned above, the application first initiates a connection with an appropriate server, and repeatedly polls the same file for new messages contained within the file. In some embodiments, the location of the server and/or the file may be hard-coded into the application. Alternatively, the location of the server and/or the file may change, and be updated on a periodic basis.

In an exemplary embodiment, the client application utilizes the HTTP connection stream of J2ME to load the message file into the mobile phone. The messages in the file are identified numerically. The client application ignores messages the it has already seen. When the client application finds a new message, it breaks the message apart into separate components. The program then acts appropriately for the message and components.

For example, consider the client program receives a message as follows:

1 msg (“q”, “Hypertension”, “Hypoglycemia”, “Neuralgla”, “Angina”, “8000”)

The client program is configured to break the message apart by parsing the message and looking for special characters. The message number is for example at the beginning of the message. The application can therefore recognize that it is message 1. The message type is for example shown, as the first string “q” of several strings delimited by commas within the parentheses. The “q” identifies that it is a question template. The four possible answers to the question (“Hypertension”, “Hypoglycemia”, “Neuralgla”, “Angina”) are then listed, separated by commas. The last string is the point value of the question. In this case, the question is worth 8000 points.

The client program then displays the answers on the mobile phone's interactive screen. The user selects an answer and presses a ‘Select’ button to attempt to guess the correct answer.

An answer message might be formatted as shown below:

2 msg (“a”, “Hypertension”, “ ”, “ ”, “O”, “, “Hypertension”, “Hypoglycemia”, “Neuralgla”, “Angina”)

When the client program receives this message, it breaks it apart into quote-separated substrings. The program sees that is a message of type “a”, or an answer message, and that the correct answer is “Hypertension.” The program compares the answer chosen by the user to the answer specified as correct in the answer message. If the choices match, the user is rewarded with a “correct” screen, displaying a reward picture and the client program awards the user the points specified in the corresponding “q” message. If the user guesses incorrectly, the user receives no points and is sent to an “incorrect” screen, which displays a second picture.

Socket Connection

In another embodiment, messages are transmitted in synchronization with a broadcast from servers located at the broadcast head end or some other central location to a mobile phone. Software at the broadcast end synchronizes and transmits messages to the mobile phone's client software. The client software then reacts to and/or displays the message appropriately.

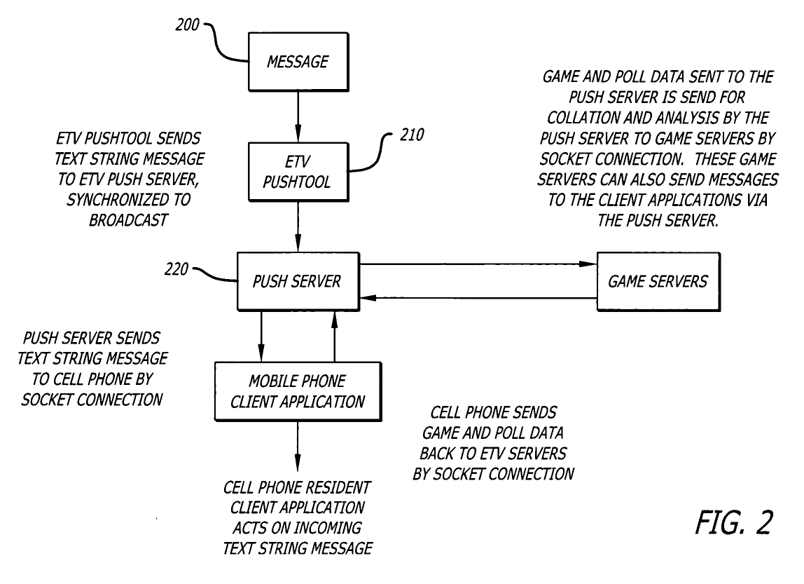

FIG. 2 is a block flow diagram illustrating an exemplary embodiment of such a socket connection implementation.

In one embodiment, client software in the form of an application that plays games, based on messages synchronized to a television broadcast is loaded onto a java enabled mobile phone. This implementation differs from the polling system indicated above and in FIG. 1. Instead of repeatedly loading a data file from a server on the Internet, the client application connects directly to a server located at the broadcast end. The server or servers comprise a message routing software technology used for distributing messages to large numbers of connected client applications.

By the client application connecting directly to the “Push Servers” instead of polling a file from a web server, latency is greatly reduced and synchronization is improved.

As illustrated in FIG. 2, messages 200 are created which relate to content found within a television or radio broadcast. The messages are passed to a software application called a “push tool” 210 which synchronizes each message with its appropriate corresponding portion within the broadcast, and transmits each message in time with the broadcast. The messages 200 are transmitted to a push server 220. The push server comprises software which accepts connections from remote devices such as mobile phones and maintains these connections.

Client application 250 running on a mobile phone initiates a socket connection with push server 220. Push server 220 acknowledges the connection and is hereby ready to transmit messages to the mobile phone client when they are received.

The client program or application may be configured to perform a variety of features as triggered by messages received from the push servers. For example, the client application may be designed such that images, animations, or sounds are displayed in response to receiving a message. Furthermore, the client application could trigger another application resident on the mobile phone to be run. Alternatively, the client could trigger the mobile phone's web browser to display content located on the Internet. Some messages may even trigger the display of a graphic in the form of an advertisement to appear on the mobile phone screen.

For example, data in the form of images, icons, graphics, backgrounds, sounds, or animations can be transmitted to the phone via the cellular network, or may already be pre-loaded in the phone's memory, perhaps through installation of the client application.

Messages transmitted to the mobile phone are formatted in a way such that the client application knows to locate the target data and appropriately display the data. For example, the message might contain the name or location of the data to be displayed.

As a result, the mobile phone could display images or animations synchronously with a television or radio broadcast. Similarly, the mobile phone could play sounds such as simple beeps or more complex musical tones in synchronization to a television broadcast.

One exemplary application in accordance with the principles of the present disclosure is a fantasy sports game. For example, the client application could be configured to perform as a fantasy baseball manager. A user is initially presented a roster of players on his phone. Using the phone as a controller, the user selects which players they want in their fantasy team roster. The user's team roster selections are saved locally to the phone's memory, or alternatively are transmitter to a server where they are save. The mobile phone receives statistics for each fantasy player from the push servers, and the client application is configured to add the points earned by selected fantasy players to the user's overall fantasy score. The client application could further be configured with many options for viewing statistics of players, and compare the user's scores or team performance with other users.

Another exemplary client application is a wireless trivia game. The phone receives a message with a question and a set of possible answers. These are displayed on the phone's screen. Using the phone's directional pad or number keys, the player chooses an answer. The chosen answer is highlighted on the screen. When the phone receives an answer message, the phone displays whether the user has chosen correctly. If their guess is correct, points are added to their overall score.

Yet another example of an application is a triggered action game. When the phone receives the correct message from the push servers, the phone switches to display an animated action game. In the game a pitcher throws a ball to a batter. Using the directional pad on the phone the user tries to hit the ball. If the player times the swing correctly and swings at the right height, they hit the ball and earn points. These points are then added to their overall score.

Synchronized sports broadcasts and/or commentary could also be transmitted to a mobile phone. This could be quite useful for those who do not have access to a television or radio. For example, messages are created such that when received by the mobile phone, display the latest events in a baseball broadcast. Messages could display how many strikes against a batter, how many balls against a batter, when the batter is out. The display could be a simple text format, or more sophisticated graphical interface. For example, the application could display a graphical overview of the field, showing who is on base and who is at bat, and even show simulated movements of players from one base to another, or where on the field the ball was hit by each batter. Certain events could trigger the display of graphics and sounds. For example, when a specific batter has hit a homerun, special graphics or sounds may be triggered by the client application.

Such an application could work in coordination with the fantasy sports game mentioned above. Scoring of a user's fantasy sports roster would be adjusted based on the plays during a game. Such an application could be implemented for any type of sport.

Furthermore, advertisements could be transmitted to a mobile phone in synchronization with the commercial advertising during a sports broadcast. Images, graphics, or animations would be displayed on the mobile phone screen during commercial breaks. It is contemplated that electronic coupons could be transmitted to a mobile phone. The electronic coupon may be in the form of an image containing a bar code, for scanning at a retail location. Alternatively, the coupon could contain text such as a number or code for use in redeeming the coupon.

In yet another embodiment, a client application running on a mobile phone enables polling of an audience by transmitting messages to user's mobile phones synchronously with a television broadcast. There are many television programs in which it has become popular to poll the audience. Reality television shows or live contests aired on television are examples of types of broadcasts that may employ polling the viewing audience.

The client application may be “hard coded” with the address of a server to which responses should be addressed. Alternatively, each message that is sent may contain the address to which the response should be sent.

Similarly, a client application could allow mobile phone users to receive choices for an opinion poll. Using the phone as an input device, a user can submit their opinions to poll collectors, Once the opinion poll data has been collected, it can be sent back to the phone to show users the results of the opinion poll.

The foregoing description of exemplary embodiments has been presented for the purposes of illustration and description. It is not intended to be exhaustive or to limit the invention to the precise form disclosed. Many modifications and variations are possible in light of the above teaching. It is intended that the scope of the present disclosure be limited not by this detailed description, but rather by the claims appended hereto.

What is claimed is:

1. A method of providing interactive content to a mobile device comprising:
creating at least one message corresponding to content within a broadcast;
writing the at least one message to a file located on a server in relative time with the corresponding content in the broadcast; and
providing read access to the file through a network connection such that a mobile device can read and display the message.

2. The method of claim 1 wherein the mobile device is a cell phone.

3. The method of claim 1 wherein the mobile device is a personal digital assistant.

4. The method of claim 1 wherein the message comprises text.

5. The method of claim 1 wherein the file is a text file.

6. The method of claim 1 wherein the file is a database record.

7. The method of claim 1 wherein writing the at least one message to a file is accomplished by software configured to transmit each message in relative time with the corresponding content as it appears in the broadcast, to label each message consecutively, and to write each message to the file.

8. A mobile telephone comprising a client application configured to perform the steps of:
initiating a network connection with a remote server;
repeatedly reading the contents of a file located on said remote server, the file comprising at least one message;
retrieving the at least one message;
parsing the message; and
displaying the content of the message on the mobile telephone display.

9. The mobile telephone of claim 8 wherein the network connection is established utilizing HTTP protocol.

10. The mobile telephone of claim 8 wherein the network connection is established utilizing TCP/IP protocol.

11. The mobile telephone of claim 8 wherein the retrieving the at least one message occurs only if the message is new.

12. A method of interacting with television content using a mobile phone, the method comprising the steps of:
transmitting message strings related to television content in synchronization with a television broadcast;
labeling the message and writing the message to a file located on a server;
creating a network connection from a mobile phone to the server;
repeatedly reading the contents of the HTTP file and loading new data into the mobile phone;
analyzing the message to see if it has been received
parsing the message; and
displaying the data on the mobile phone display.

13. The method of claim 12 wherein the network connection is established utilizing HTTP protocol.

14. The method of claim 12 wherein the network connection is established utilizing TCP/IP protocol.

15. The method of claim 12 wherein the network connection is a persistent connection.

16. The method of claim 12 wherein the network connection is a non-persistent connection that is established repeatedly.

17. The method of claim 12 wherein labeling comprises numbering the messages in consecutive order and appending each new message to the file.

18. The method of claim 12 wherein the message comprises a question related to the content of the television broadcast.

19. The method of claim 18 wherein the message further comprises a set of possible answers to the question.

20. The method of claim 18 further comprising the step of receiving user input in response to display of the data.

21. A method of interacting with television content via a mobile phone, the method comprising the steps of:
transmitting message strings related to television content in synchronization to a television broadcast to routing software;
providing a mobile phone with a client application capable of creating a socket connection to the routing software;
receiving message strings through the socket connection;
parsing the message string; and
displaying the data on the mobile phone display.
